(19) United States
(12) Patent Application Publication
(10) Pub. No.: US 2011/0261699 A1
(43) Pub. Date: Oct. 27, 2011

(54) SERVER APPARATUS AND COMMUNICATION SYSTEM AND METHOD OF CONTROLLING USED IN SERVER APPARATUS

(76) Inventor: Toshio Nishida, Hino-shi (JP)

(21) Appl. No.: 13/084,375

(22) Filed: Apr. 11, 2011

(30) Foreign Application Priority Data
Apr. 26, 2010 (JP) 2010-101488

(51) Int. Cl. H04L 12/66; H04L 12/26

(52) U.S. Cl. 370/241; 370/352

(57) ABSTRACT

According to one embodiment, a server apparatus includes a license memory, a license setting module, an information memory, an acquiring module, a determining module and a controller. The license memory selectively stores a license code provided by a license issuing module. The license setting module sets the corresponding function or the corresponding hardware circuit to be usable/unusable based on the license code stored in the license memory. The information memory stores information of at least a part of the license code. The acquiring module acquires the license code corresponding to the function or the hardware circuit to be changed by communication with the license issuing module. The determining module determines whether or not the license code acquired by the acquiring module is valid by comparing the license code with the information stored in the information memory. The controller stores the valid license code in the license memory.

### CROSS-REFERENCE TO RELATED APPLICATIONS

This application is based upon and claims the benefit of priority from Japanese Patent Application No. 2010-101488, filed Apr. 26, 2010; the entire contents of which are incorporated herein by reference.

### FIELD

Embodiments described herein relate generally to a server apparatus which changes a function or a hardware circuit to be usable/unusable by a license code, and a communication system and method of controlling used in server apparatus.

### BACKGROUND

In an office, a school, a business office or the like, there is often used electronic office equipment such as an electronic premise exchange, a button phone set, a facsimile apparatus or a copier. When the electronic office equipment is purchased and used, a user usually selects the equipment having necessary functions at the time.

After the start of use, however, it may be required to add a function of the equipment in accordance with the increase of manpower, the change of business contents or the like, or conversely it may be required to eliminate an unnecessary function. In such a case, in a conventional system, some functions are beforehand carried on the equipment, and to provide the necessary function, a license code is usually input to the equipment to utilize a part or all of the functions. Furthermore, also for utilization limitation and cancellation of the number of terminals for utilizing the functions or a memory capacity for utilizing the functions, the license code is usually used.

In such utilization limitation and cancellation by use of the license code, the beforehand limited functions or capacity can be cancelled by inputting the license code, but for the purpose of transferring a license to another system or returning the license code, the functions or capacity which has been utilizable in the system cannot be limited. This is designed to permit recovering the function or the capacity by inputting the already issued license code again, even if the function is once limited or the capacity is decreased.

As methods of realizing the function/capacity limitation by use of the license after the utilization start, an expiration date may be set to the license code to periodically update the license, or the utilization of the function may be set to a meter rate. In such cases, however, there are disadvantages that the license code needs to be beforehand issued under such conditions, and the functions are used until the term expiration of the license code.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic constitutional view of a communication system according to a first embodiment;

FIG. 2 shows one example of a stored contents of a user database shown in FIG. 1;

FIG. 3 is a block diagram showing a function constitution of a call control server according to the first embodiment shown in FIG. 1;

FIG. 4 shows one example of stored contents of a service execution table shown in FIG. 3;

FIG. 5 shows a data structure of a license code handled in the first embodiment;

FIG. 6 is a sequence diagram showing an information transmitting/receiving operation among a personal computer PC (a user PC) for maintenance of a user system, a license issuing server, and a credit company in a case where a function is added to the call control server in the first embodiment;

FIG. 7 shows one example of a screen downloaded from the license issuing server in the case where the function is added to the call control server in the first embodiment;

FIG. 8 is a flowchart showing a control processing procedure of the call control server in a case where the license code is received in the first embodiment;

FIG. 9 is a block diagram showing a function constitution of a call control server according to a second embodiment; and

FIG. 10 is a sequence diagram showing an operation when a license code to limit a function which has once been utilizable is input in the second embodiment.

### DETAILED DESCRIPTION

Various embodiments will be described hereinafter with reference to the accompanying drawings. In general, according to one embodiment, a server apparatus registering a plurality of phone terminals, comprising: a license memory configured to selectively store a license code provided by a license issuing module, wherein the license code is code to permit the use of at least one function or hardware circuit among a plurality of functions or hardware circuits or to expand a capacity, wherein the plurality of functions or hardware circuits is concerned with exchange processing among the phone terminals; a license setting module configured to set the corresponding function or the corresponding hardware circuit to be usable/unusable based on the license code stored in the license memory; an information memory configured to store information of at least a part of the license code; an acquiring module configured to acquire the license code corresponding to the function or the hardware circuit to be changed by communication with the license issuing module, when a change request of the function or the hardware circuit occurs; a determining module configured to compare the license code with the information stored in the information memory, and determine whether or not the license code acquired by the acquiring module is valid based on a comparison result, and generate a valid license code when license code is determined to be valid; and a controller configured to store the valid license code in the license memory.

### First Embodiment

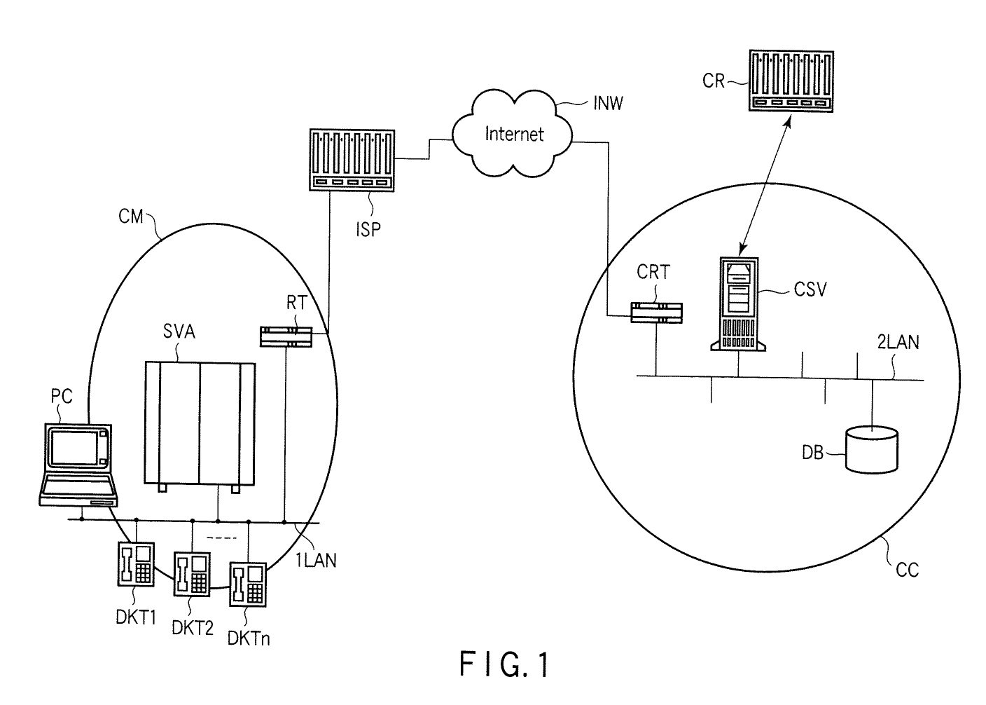

FIG. 1 is a schematic constitutional view of a communication system according to a first embodiment of the present invention. In the drawing, CM is a user system, CC is a service providing center of an exchange maker, and CR is a credit company, respectively.

The user system CM comprises a call control server SVA, IP phone terminals DKT1 to DKTn, a personal computer PC and a router RT, and they are connected to one another via LAN1. The call control server SVA has, as a basic function, a function to register the IP phone terminals DKT1 to DKTn, a function to perform exchange/connection among the IP phone terminals DKT1 to DKTn themselves and among the IP phone terminals DKT1 to DKTn and subscriber lines of a public network (not shown) in response to outgoing/incoming signals, and additionally the server has a plurality of optional service functions concerned with this exchange/connection processing. Examples of these optional service functions include a call pickup function, a call forward function, and a multi-appearance function.

The router RT is connected to an internet INW via a provider ISP, and is further connected to the service providing center CC from the internet INW. The service providing center CC comprises a license issuing server CSV, a user database DB, and a router CRT, and they are connected to one another via LAN2. The license issuing server CSV is connected to the internet INW via the router CRT to communicate with the contracted user system CM about the information of function setting. Moreover, the license issuing server CSV has a function of sending a license code to the call control server SVA to perform the addition setting or limitation of the function. This license code includes an instruction code for activating the function and a system ID.

Furthermore, the license issuing server CSV is connected to the credit company CR via, for example, a private line, and performs the settlement of an expense required for the function setting with the credit company CR.

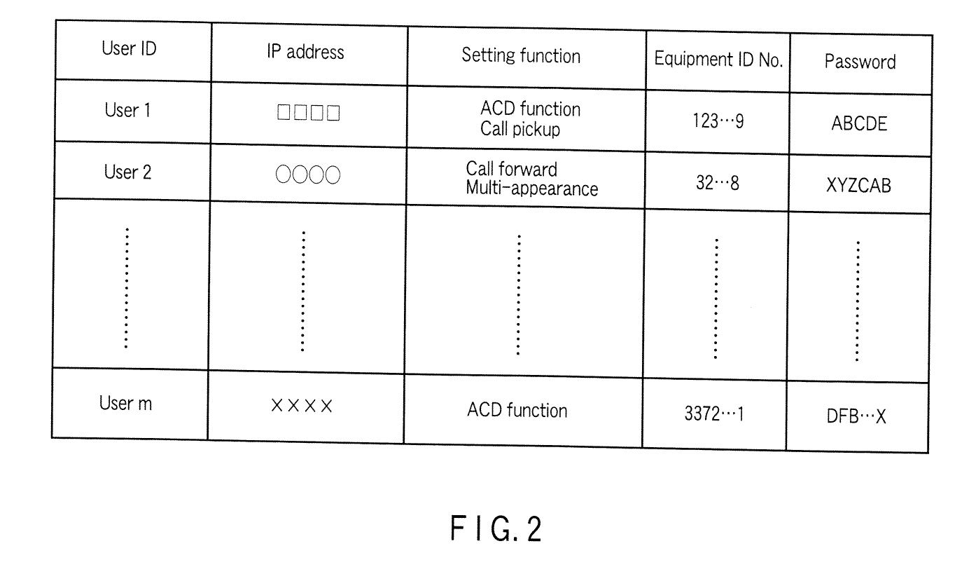

FIG. 2 shows the user database DB. In the user database DB, there are stored an IP address assigned to each user, setting functions of a call control server SVA (including a settable function) of the user, an equipment identification number as confidential information given to the user, and a password as authentication information, in association with an individual identification number (a user ID) assigned to the user. Here, examples of the setting function include an ACD function, a voice mail function, and a private line network function.

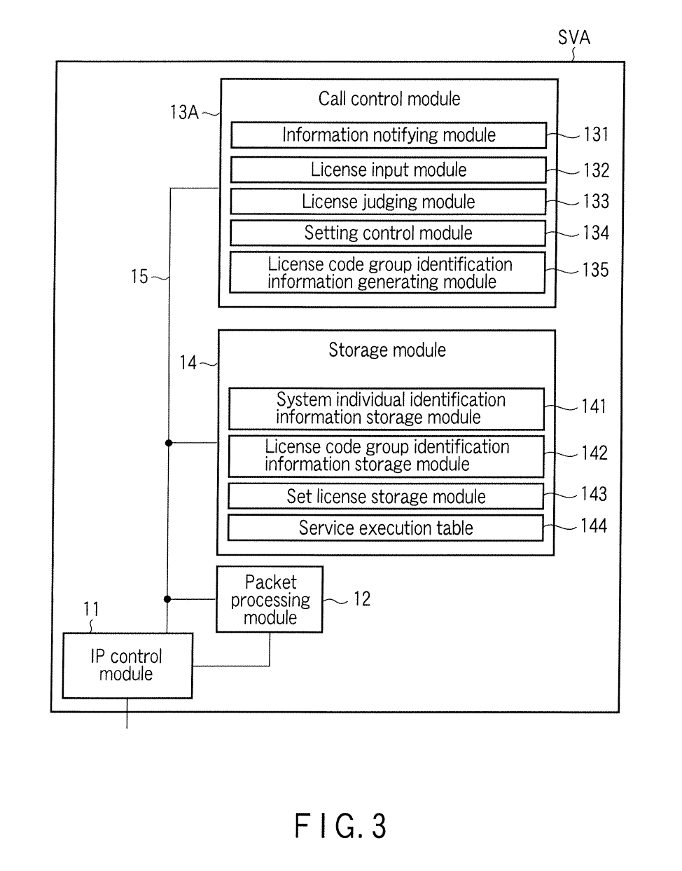

FIG. 3 is a block diagram showing a constitution of the call control server SVA.

That is, the call control server SVA comprises an IP control module 11, a packet processing module 12, a call control module 13A, and a storage module 14. The IP control module 11, the packet processing module 12, the call control module 13A and the storage module 14 are connected to one another via a data highway 15.

The IP control module 11 is connected to the LAN1 if necessary. The IP control module 11 performs interface processing with the connected LAN1. Moreover, the IP control module 11 transmits/receives various pieces of control information concerning the above interface processing to/from the call control module 13A via the data highway 15.

The packet processing module 12 processes an RTP packet received in the IP control module 11.

The call control module 13A is constituted of a CPU, a ROM, a RAM and the like to control the respective units of the call control server SVA by software processing.

In the storage module 14, a program which realizes the above optional service function is beforehand stored. Moreover, the storage module 14 is provided with a system individual identification information storage module 141 (hereinafter referred to as the storage module 141), a license code group identification information storage module 142 (hereinafter referred to as the storage module 142), a set license storage module 143 (hereinafter referred to as the storage module 143), and a service execution table 144. In the storage module 141, system individual identification information (the system ID) beforehand given at a shipping time of the call control server SVA is stored. As this system individual identification information, an MAC address of the call control server SVA, an ID of the CPU, or an identification code of the ROM is used.

In the storage module 142, license code group identification information indicating that one or a plurality of license codes belong to the same group is stored. In the storage module 143, the license code issued from the license issuing server CSV is stored.

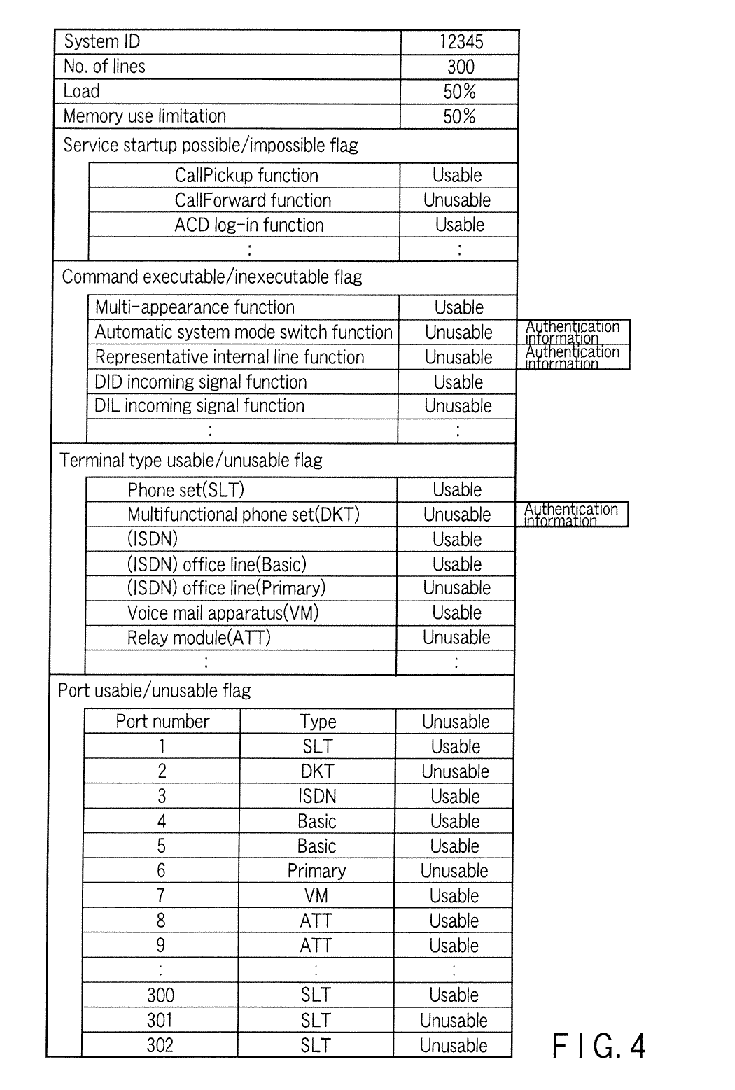

The service execution table 144 shown in FIG. 4 is a table for managing a set state of the optional service function, and in the table 144, flags indicating that the respective optional service functions are usable or unusable are stored. When the usable/unusable flag is set to “usable”, the corresponding function can be executed. On the other hand, when the flag is set to “unusable”, the function cannot be executed.

On the other hand, the call control module 13A comprises an information notifying module 131, a license input module 132, a license judging module 133 as determining module, a setting control module 134, and a license code group identification information generating module 135 (hereinafter referred to as the information generating module 135). When a request for change of the function occurs, the information notifying module 131 notifies the license issuing server CSV of contents of the change together with the system individual identification information stored in the storage module 141 and the license code group identification information stored in the storage module 142.

The license input module 132 inputs the license code sent from the license issuing server CSV with respect to the above notification by the information notifying module 131.

The license judging module 133 determines whether or not the above license code is a valid license issued for the call control server SVA based on the information stored in the storage modules 141 and 142. Moreover, determination concerning an input order of licenses described later is also performed by this module.

The setting control module 134 stores the license code determined to be valid by the license judging module 133 in the storage module 143, and changes the flag of the corresponding function in the service execution table 144 from “unusable” to “usable”, or from “usable” to “unusable” in accordance with the license code stored in the storage module 143. It is to be noted that authentication information indicating that the information has been issued by the license issuing server CSV is added to the function information changed from “usable” to “unusable”, and stored in the storage module 143. As this authentication information, for example, the system individual identification information, or the equipment identification number or password registered in the database DB of the service providing center CC is used. Moreover, the authentication information is associated with the corresponding function in the service execution table 144 and stored.

When a system memory is initialized or every instruction is given to the call control server SVA, the information generating module 135 generates the license code group identification information, which is beforehand stored in the storage module 142. As the license code group identification information, for example, present time information (dominical year, month, day, time, and second) or another random information is used. Moreover, as conditions for generating the license code group identification information, a predetermined time zone may be used.

Moreover, even when the information stored in the storage module 142 is erased, the information generating module 135 generates new license code group identification information, which is stored in the storage module 142.

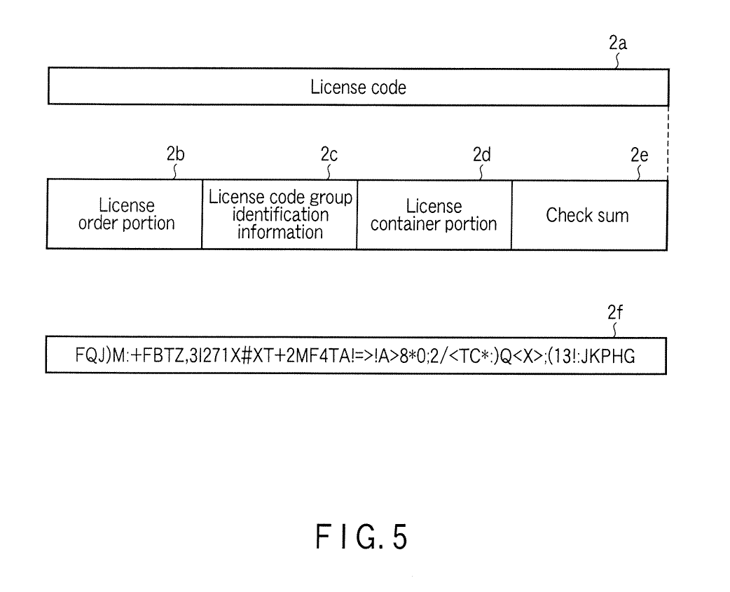

First, the license code to be handled in the first embodiment will be described. FIG. 5 shows a data structure of the license code. A license code 2a is usually a data row constituted of ASCII characters and the like. The data row is encrypted sometimes so that the contents thereof are not deciphered.

Moreover, in the license code 2a, information of a license order portion 2b, license code group identification information 2c, a license container portion 2d and a check sum 2e is stored. The license order portion 2b is information indicating an order in which the licenses have been issued, and the license container portion 2d includes information concerning a function which can be utilized by the license code 2a, a function to limit the utilization, the number of hardware circuits to be increased, and the number of hardware circuits to be decreased. The check sum 2e is data for authenticating that the license code 2a has been issued for the call control server SVA, and the data is generated by using the system individual identification information and the license code group identification information.

When the license code 2a is encrypted, decryption processing is performed sometimes by using the system individual identification information and the license code group identification information. In this case, the check sum 2e is not explicitly included sometimes. Moreover, the license code group identification information 2c is indirectly used when calculating the check sum 2e, and hence the license code group identification information does not necessarily have to be included in the license code 2a. 2f is a specific example of the license code 2a constituted of alphanumeric characters. The license code 2a is usually converted into legible characters as in the specific example 2f, but may be converted into any format.

Next, a procedure for adding the function to the call control server SVA will be described.

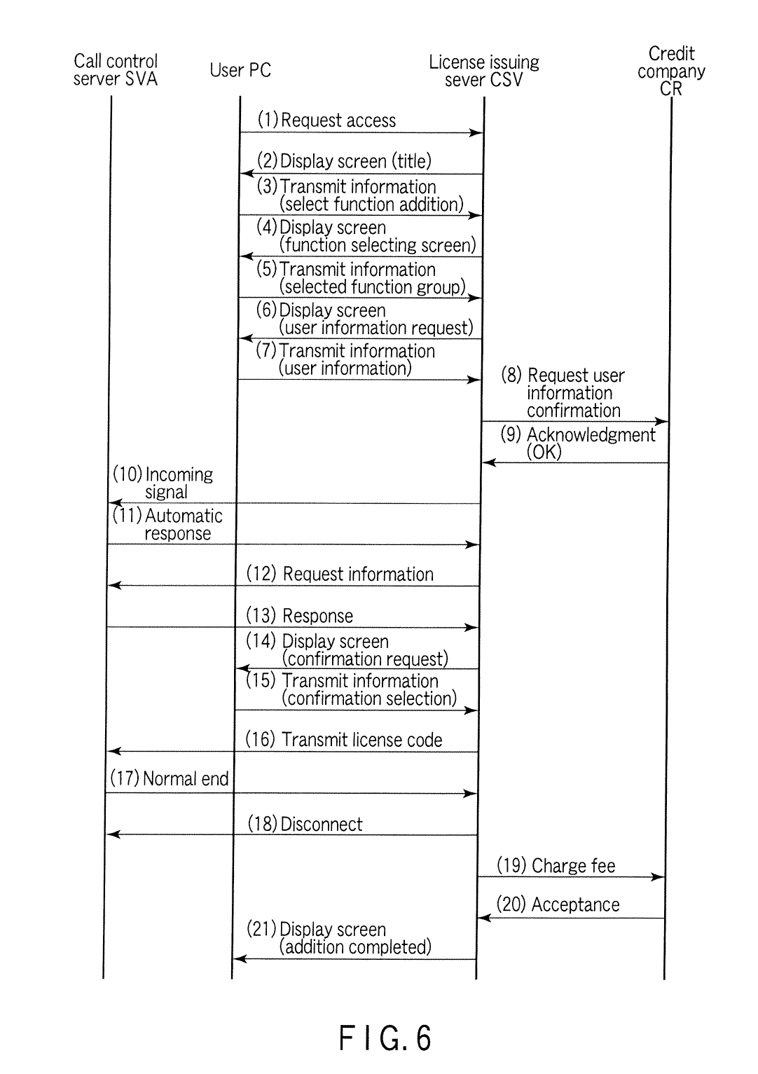

FIG. 6 is a sequence diagram showing a transmitting/receiving operation of the information among the personal computer PC (the user PC) for maintenance of the user system CM, the license issuing server CSV, and the credit company CR.

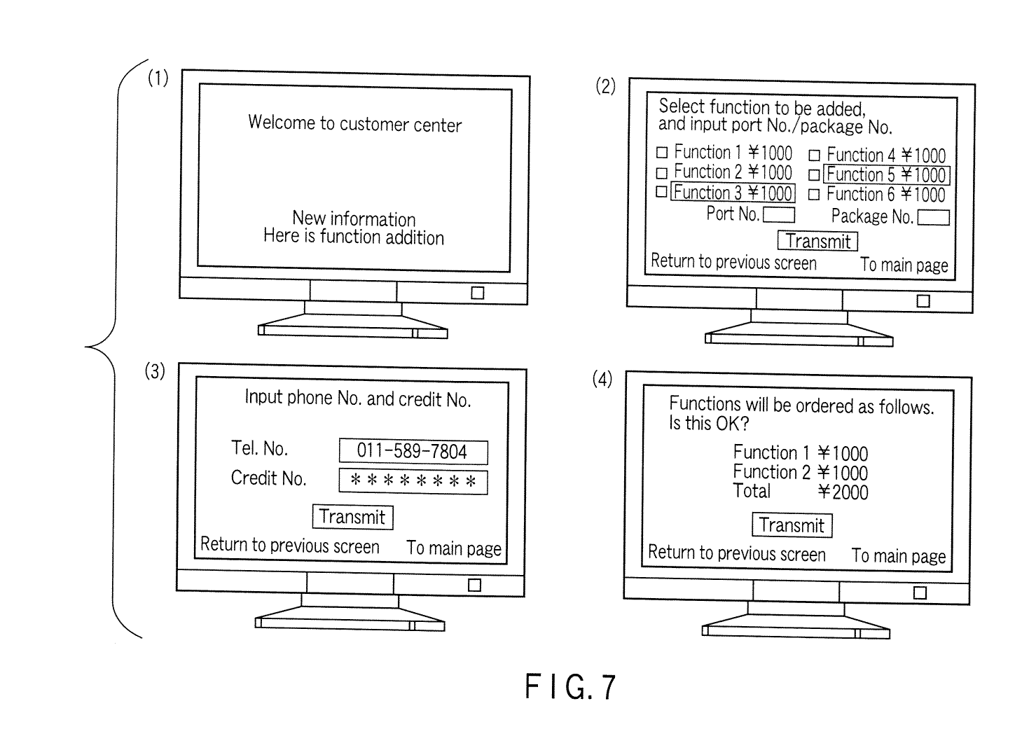

When the function of the call control server SVA is added, a user accesses the license issuing server CSV via the internet INW by use of the personal computer PC for maintenance (FIG. 6(1)). In this case, the personal computer PC for maintenance receives screen information from the license issuing server CSV (FIG. 6(2)), to display a screen shown in FIG. 7(1). Here, when the user uses the personal computer PC for maintenance and clicks “addition of function” in the screen (FIG. 6(3)), the personal computer PC for maintenance receives the next screen information from the license issuing server CSV (FIG. 6(4)), to display the screen shown in FIG. 7(2).

Here, when, for example, “function 1” or “function 2” is selected and then “transmit” is clicked, the personal computer PC for maintenance transmits the selected information to the license issuing server CSV (FIG. 6(5)). Afterward, the computer receives a user information request (FIG. 6(6)), to display the screen shown in FIG. 7(3).

Here, when a phone number and a credit number are input in the screen and then “transmit” is clicked, the personal computer PC for maintenance transmits the input information to the license issuing server CSV (FIG. 6(7)).

On receiving the function adding request including the input information, the license issuing server CSV first accesses the credit company CR via a private line, to inquire about the credit of the user based on the credit number (FIG. 6(8)) of the user. With respect to this inquiry, the credit company CR judges whether or not there is an account corresponding to the credit number, whether or not the expiration date for use of the credit is within term of validity, and whether or not use stop is set. Moreover, the credit company returns a response to the license issuing server CSV (FIG. 6(9)).

The license issuing server CSV judges the credit of the user based on the response from the credit company CR, and accesses the call control server SVA of the user via the internet INW based on the phone number included in the above function adding request if there is not any problem (FIG. 6(10) and FIG. 6(11)), to acquire the system individual identification information and the license code group identification information from the call control server SVA (FIG. 6(12) and FIG. 6(13)). Then, the license issuing server CSV determines, based on the acquired information, whether or not the function desired to be added by the user can be added, and notifies the personal computer PC of the user for maintenance of this judgment result together with an expense required for the addition of the function (FIG. 6(14)). In this case, the personal computer PC for maintenance displays a screen shown in FIG. 7(4). It is to be noted that as conditions for judging whether or not the function can be added, authentication information recorded for the “unusable” function is used. When it is judged that the function cannot be added, the license issuing server CSV urges the user of the personal computer PC for maintenance to input the password for use as the authentication information. Moreover, only when the password matches, the license code which sets to “usable” is transmitted to the call control server SVA.

Then, on receiving an acknowledgement of this notification from the user (FIG. 6(15)), the license issuing server CSV transmits the license code as function change control information to the call control server SVA of the user via the internet INW (FIG. 6(16)). This license code includes an instruction code for setting the added function to “usable”. At this time, the instruction code is encrypted by the system individual identification information and license code group identification information beforehand acquired from the call control server SVA.

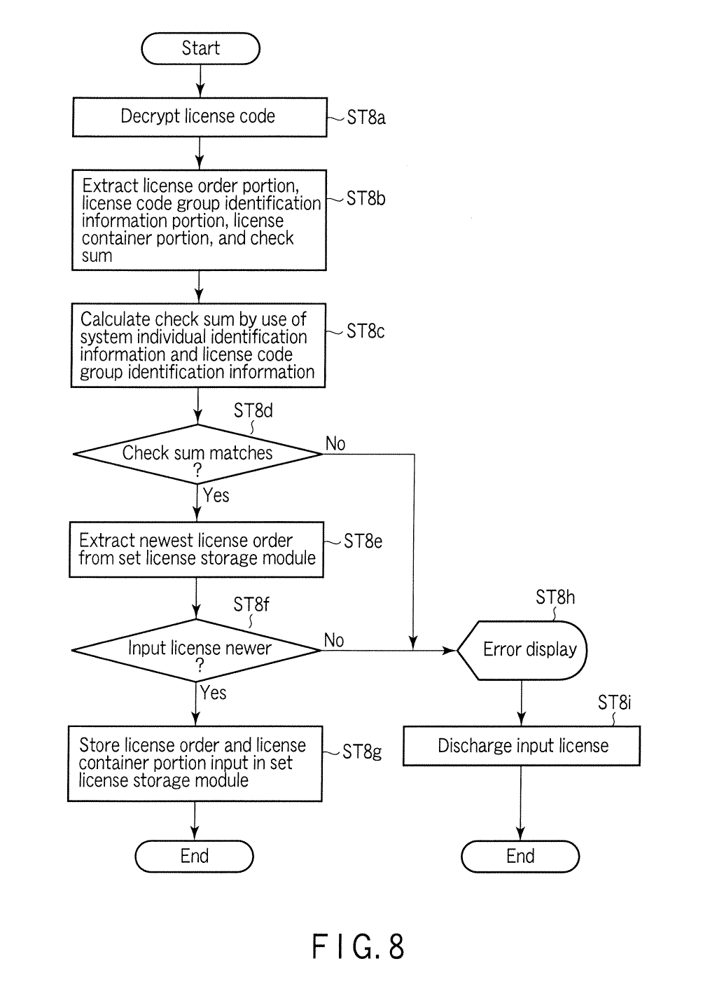

On receiving the above license code, the call control server SVA executes a control processing procedure shown in FIG. 8.

On receiving the license code from the license issuing server CSV, the call control server SVA first decrypts this license code by use of the system individual identification information and license code group identification information of the server itself (block ST8a). The call control server SVA extracts the license order portion, license code group identification information portion, license container portion and check sum included in this decrypted license code (block ST8b), and further calculates the check sum by use of the information stored in the storage modules 141 and 142, respectively (block ST8c), to judge whether or not the check sum matches (block ST8d).

Here, when the check sum matches (Yes), the call control server SVA reads the newest license order portion from the storage module 143 (block ST8e), and determines whether or not the license order portion of the received license code is newer than this read license order portion (block ST8f).

Here, when the call control server SVA determines that the license order portion of the received license code is newer (Yes), the server SVA stores the license order portion and license container portion of the received license code in the storage module 143 (block ST8g), and changes the flag of the corresponding function in the service execution table 144 from “unusable” to “usable” in accordance with the data of the license container portion. When this function setting processing ends, the call control server SVA returns, to the license issuing server CSV, information indicating that the function adding processing has normally ended (FIG. 6(17)).

On receiving the above function addition end notification from the call control server SVA, the license issuing server CSV disconnects a line between the call control server SVA and the license issuing server (FIG. 6(18)), and then accesses the credit company CR to request for settlement of a function adding fee. In this case, the license issuing server CSV calculates an amount to be charged for each function which is desired to be added by the user and actually set to be usable in reply to this desire, and prepares an electronic bill of particulates. For example, when the user desires the addition of functions 1 and 2, the license issuing server adds up an addition fee (=1000 yen) of the function 1 and an addition fee (1000 yen) of the function 2 to calculate the total amount (=2000 yen), and prepares the electronic bill of particulates. Then, the license issuing server includes this electronic bill of particulates in settlement request information to transmit the information to the credit company CR (FIG. 6(19)).

On receiving this settlement request information, the credit company CR first performs user authentication and judges whether or not transaction can be performed, based on the credit number of the user included in this settlement request information. Then, if the transaction can be performed, the credit company performs the settlement acceptance processing of the expense based on the electronic bill of particulates included in the above settlement request information. Then, after the end of this settlement acceptance processing, the credit company returns, to the license issuing server CSV as a requester, a response indicating that the settlement request has been accepted (FIG. 6(20)).

On receiving the acknowledgment of the above settlement request from the credit company CR, the license issuing server CSV transmits information indicating that the function adding processing has ended to the personal computer PC of the user for maintenance, to display the information in the computer PC (FIG. 6(21).

In this manner, the function desired to be added by the user is set to be usable by the call control server SVA. Afterward, in the call control server SVA of the user, this added new optional service function can be used.

It is to be noted that when it is judged in the block ST8d that the check sum does not match (No), the call control server SVA supplies an error message to the personal computer PC for maintenance to display the message in the computer (block ST8h), and discards the received license code (block ST8i).

Moreover, when it is determined in the block ST8f that the license order portion of the received license code is old (No), the call control server SVA supplies the error message to the personal computer PC for maintenance to display the message in the computer, and discards the received license code. After discarding the received license code, the call control unit 13A of the call control server SVA erases the license code group identification information in the license code group identification information storage module 142, and then generates new license code group identification information in the license code group identification information generating module 135.

Moreover, when the license issuing server CSV acquires the system individual identification information and the license code group identification information from the call control server SVA, the system individual identification information and the license code group identification information can once be displayed in the personal computer PC for maintenance, and after waiting for an instruction of the user, the system individual identification information and the license code group identification information can be transmitted to the license issuing server CSV.

Furthermore, the license issuing server CSV can transmit, to the call control server SVA, a license code for changing a hardware circuit such as a voice mail apparatus or a relay unit from “usable” to “unusable”, in addition to the license code for changing the function from “usable” to “unusable”.

Additionally, the license issuing server CSV can transmit, to the call control server SVA, a license code for changing memory use limitation in the service execution table 144 from “50%” to “75%”. In consequence, expansion of a memory capacity of the call control server SVA can be achieved.

As described above, in the first embodiment, prior to the changing of the function or the hardware circuit to the usable/unusable state, the call control server SVA notifies the license issuing server CSV of the system individual identification information and the license code group identification information generated in accordance with conditions such as an instruction from the outside, a reset time and a random, to generate the license code. By the utilization of the system individual identification information and the license code group identification information, the validity of the license code sent from the license issuing server CSV is judged, the only valid license code is stored in the storage module 143. In consequence, in accordance with this license code, the flag of the corresponding function in the service execution table 144 is changed from “unusable” to “usable”.

Therefore, all the license codes generated with reference to old license code group identification information are invalidated, whereby re-inputting of the license code for changing the function or hardware circuit set to be unusable by this invalidation to the usable state can be prevented. Moreover, the user of the call control server SVA can readily use the function or hardware circuit to be used.

Moreover, in the first embodiment, the call control server SVA compares the license order portion of the license code received from the license issuing server CSV with the license order portion stored in the storage module 143, and determines whether or not the license code received form the license issuing server CSV is new based on this comparison result. When the call control server SVA determines that the license code received from the license issuing server CSV is new, the call control server SVA stores the license order portion and license container portion of the received license code in the storage module 143.

Therefore, the re-inputting of the old license code can be prevented.

Moreover, in the first embodiment, it is judged, by utilizing the license order portion, whether or not the license code determined to be valid by utilizing the check sum is new, whereby reliability in the determination of the validity of the license code can further be improved.

Furthermore, in the first embodiment, the system individual identification information and the license code group identification information can once be displayed in a display of the personal computer PC for maintenance, and after waiting for an instruction of the user, the license issuing server CSV is notified of the system individual identification information and the license code group identification information. In consequence, it is possible to notify the license issuing server CSV of the only system individual identification information and license code group identification information required by the user.

### Second Embodiment

In a second embodiment of the present invention, when a “usable” function is changed to “unusable”, a license code of a function to be limited is sent to a call control server to limit the corresponding function.

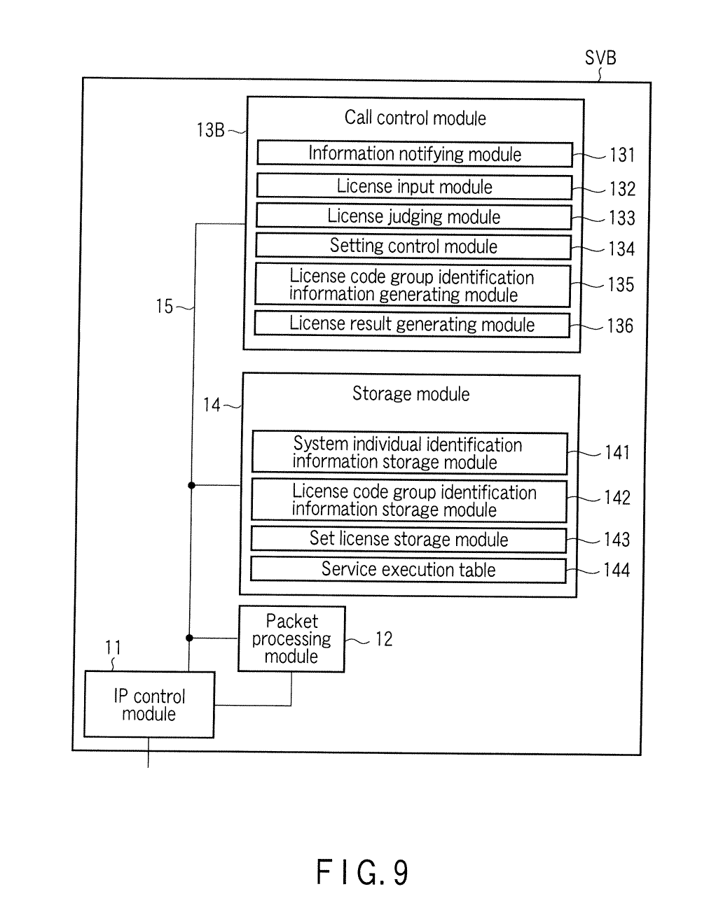

FIG. 9 is a block diagram showing a function constitution of a call control server SVB according to the second embodiment. In FIG. 9, the same part as that of FIG. 3 described above is denoted with the same reference numerals and detailed description thereof is omitted.

That is, a call control module 13B further comprises a license change result generating module 136 (hereinafter referred to as the generating module 136). The generating module 136 stores the license code in a storage module 143, and then notifies a license issuing server CSV of change contents concerning the function.

Next, an operation of the above constitution will be described.

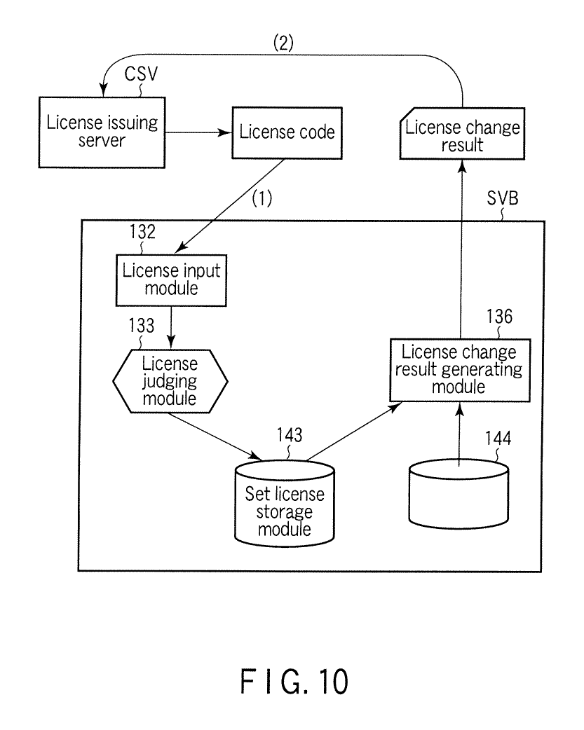

FIG. 10 is a sequence diagram showing an operation when the license code to limit the function which has once been utilizable is input.

When the function of the call control server SVB is limited, a user uses a personal computer PC for maintenance to access a customer center CC via an internet INW, and inputs necessary matters concerning the function limitation in accordance with guidance of a screen downloaded from the customer center CC. The necessary matters to be input include information indicating the function to be limited, and a phone number or IP address assigned to the call control server SVB. Then, when the input of these necessary matters ends, a function limiting request including the information is transmitted to the license issuing server CSV.

The license issuing server CSV which has received the above function limiting request accesses the call control server SVB to acquire system individual identification information and license code group identification information. Then, the license issuing server CSV determines, based on the acquired information, whether or not the function desired to be added by the user can be limited, and notifies the user's personal computer PC for maintenance of this determination result.

Then, on receiving an acknowledgment of this notification from the user, the license issuing server CSV transmits the license code as function change control information to the user's call control server SVB via the internet INW (FIG. 10(1)). This license code has an inserted instruction code for setting the function to be limited to “unusable”. At this time, this instruction code is encrypted by the system individual identification information and license code group identification information beforehand acquired from the call control server SVB.

On receiving the above license code by a license input module 132, the call control server SVB first decrypts this license code by use of the system individual identification information and license code group identification information of the server itself. The call control server SVB extracts a license order portion, a license code group identification information portion, a license container portion and a check sum included in this decrypted license code, and further calculates the check sum by use of information stored in storage modules 141 and 142, respectively, to judge, by a license judging module 133, whether or not the check sum matches.

Here, when the check sum matches, the call control server SVB reads the newest license order portion from the storage module 143, and judges whether or not the license order portion of the received license code is newer than this read license order portion.

Here, when the call control server SVB determines that the license order portion of the received license code is newer, the server SVB stores the license order portion and license container portion of the received license code in the storage module 143, and changes the flag of the corresponding function in a service execution table 144 from “usable” to “unusable” in accordance with the data of this license container portion. When this function setting processing ends, the generating module 136 of the call control server SVB generates, for example, a license change result indicating that a flag of “ACD log-in function” is changed from “usable” to “unusable” and that a flag of “DID incoming signal function” is changed from “usable” to “unusable” with reference to information stored in the service execution table 144.

The call control server SVB notifies the license issuing server CSV of the license change result generated in this manner. The license issuing server CSV having received this notification records, in a database DB, data indicating that the utilization of the function is limited by an issued license.

On receiving the above license change result from the call control server SVB, the license issuing server CSV disconnects a line between the call control server SVB and the license issuing server, and then calculates a refund of a license purchase price based on the above license change result. In this case, the license issuing server calculates the refund in proportion to the number of the functions changed from “usable” to “unusable”.

Then, after the end of the above refund calculation processing, the license issuing server CSV transmits information indicating payment of the refund to the personal computer PC for maintenance of a requester, and urges the requester to input, for example, an account number so that the above refund is paid to a designated account.

Moreover, when a response indicating the payment to the designated account is obtained from the personal computer PC for maintenance, the license issuing server CSV executes the processing of paying the refund. It is to be noted that a method of paying the refund by mail may be used if desired by the user.

Furthermore, in the second embodiment, instead of the payment of the above refund, control of the license to use the limited function can be transferred to a call control server other than the call control server SVB. In this case, on receiving the above license change result from the call control server SVB, the license issuing server CSV disconnects a line between the call control server SVB and the license issuing server, and transmits, to the personal computer PC for maintenance of the requester, information indicating that the control of the license of the limited function is transferred to another call control server, to urge the requester to input, for example, a phone number or IP address of the call control server to which the control of the function is to be transferred.

Then, when the license issuing server CSV is notified, from the personal computer PC for maintenance, of the phone number or the IP address of the desirable call control server to which the control of the license is to be transferred, the license issuing server CSV accesses the desirable call control server to acquire system individual identification information and license code group identification information. Then, the license issuing server CSV determines, based on the acquired information, whether or not the function limited by the call control server SVB of a transferor can be used, and notifies the personal computer PC of the user for maintenance of this determination result.

Then, on receiving an acknowledgment of this notification from the user, the license issuing server CSV transmits a license code, which changes the flag of the corresponding function to “usable”, to the desirable call control server of the user via the internet INW.

In this manner, the function limited by the call control server SVB is set to the usable state in the other call control server. Afterward, in the other call control server, the optional service function which has been used in the call control server SVB of the transferor can be used. It is to be noted that also in a hardware circuit such as a voice mail apparatus, control of a license of the hardware circuit subjected to use limitation by the call control server SVB of the transferor may be transferred to another call control server.

As described above, in the second embodiment, since the call control server SVB notifies the license issuing server CSV of the change result of the function or the hardware circuit by the license code, a license issuing server CSV side can manage the usable/unusable state of the function or the hardware circuit, whereby the previous change result can be reflected in the next license issuances.

Moreover, in the second embodiment, when a service providing center CC side changes the function or hardware circuit of the call control server SVB from the “usable” state to the “unusable” state, the refund of the license purchase price is calculated in accordance with the number of the limited functions or hardware circuits, and paid to the user of the call control server SVB. Therefore, the user of the call control server SVB can receive the refund in accordance with the number of the functions subjected to utilization limitation or the number of the hardware circuits changed to the unusable state in a case where the licenses of the functions or the hardware circuits have been once purchased. Moreover, instead of the reception of the refund, the control of the license may be transferred to another call control server held by the user. In consequence, when the function or the hardware circuit is effectively utilized, convenience noticeably improves.

### Other Embodiments

The present invention is not limited to the above embodiments. In the above embodiments, the license issuing server sends, to the call control server, the only license code corresponding to the function to be added or limited, and the flag of the additional function is set to be “usable” by this license code. However, license codes of all functions including the license code corresponding to the function to be added or limited may be sent, thereby rewriting the whole service information table of the call control server.

Moreover, in the first embodiment, the example has been described in which as the conditions for generating the license code group identification information by the license code group identification information generating module, the instruction to the call control server, the reset of the system memory and the random are used, but other conditions may be used.

Additionally, the procedure or contents of function change, the constitution or operation contents of the communication system, the constitution of the call control server and the like can variously be modified and implemented without departing from the scope of this invention.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A server apparatus registering a plurality of phone terminals, comprising:
a license memory configured to selectively store a license code provided by a license issuing module, wherein the license code is code to permit the use of at least one function or hardware circuit among a plurality of functions or hardware circuits or to expand a capacity, wherein the plurality of functions or hardware circuits is concerned with exchange processing among the phone terminals;
a license setting module configured to set the corresponding function or the corresponding hardware circuit to be usable/unusable based on the license code stored in the license memory;
an information memory configured to store information of at least a part of the license code;
an acquiring module configured to acquire the license code corresponding to the function or the hardware circuit to be changed by communication with the license issuing module, when a change request of the function or the hardware circuit occurs;
a determining module configured to compare the license code with the information stored in the information memory, and determine whether or not the license code acquired by the acquiring module is valid based on a comparison result, and generate a valid license code when license code is determined to be valid; and
a controller configured to store the valid license code in the license memory.

2. The server apparatus of claim 1, wherein the information memory stores system individual identification information beforehand given at a shipping time of the server apparatus, and license code group identification information indicating that one or a plurality of license codes belong to the same group,
the acquiring module notifies the license issuing module of change contents as well as the system individual identification information and the license code group identification information stored in the information memory, to generate the license code, when the change request occurs,
the determine module determines whether or not the system individual identification information and the license code group identification information at a time of notification thereof to the license issuing module match the system individual identification information and the license code group identification information included in the license code acquired from the license issuing module, and
the controller stores the valid license code in the license memory, when the system individual identification information and the license code group identification information match.

3. The server apparatus of claim 2, further comprising:
an information generator configured to generate the license code group identification information based on predetermined conditions to store the license code group identification information in the information memory.

4. The server apparatus of claim 3, wherein the information generator uses at least one of an instruction from the outside, a reset time and a random for judgment of the conditions.

5. The server apparatus of claim 2, wherein the determining module compares the system individual identification information and the license code group identification information obtained by a check sum with the system individual identification information and the license code group identification information at the time of the notification thereof to the license issuing module, when the check sum is added to the license code, wherein the check sum authenticates that the license code is issued by using the system individual identification information and the license code group identification information.

6. The server apparatus of claim 2, wherein the determining module compares the order identification information with order identification information of the license code stored in the license memory, and determines whether or not the license code acquired from the license issuing module is new based on a comparison result, when order identification information indicating an application order of the license code is added to the license code, and
the controller stores the license code in the license memory, when the determining module determines that the license code acquired from the license issuing module is new.

7. The server apparatus of claim 6, wherein the determining module determines whether or not the system individual identification information and the license code group identification information at the time of the notification thereof to the license issuing module match the system individual identification information and the license code group identification information included in the license code acquired from the license issuing module, and
the determining module compares order identification information of the license code which is determined to match, with the order identification information of the license code stored in the license memory, and determines whether or not the license code acquired from the license issuing module is new, based on the comparison result.

8. The server apparatus of claim 2, wherein the controller stores the license code in the license storage module or ignores the license code, erases the license code group identification information stored in the information memory, and then generates new license code group identification information in the information generator.

9. The server apparatus of claim 2, further comprising:
a notifying module which notifies the license issuing module of change contents concerning the function or the hardware circuit, after storing the license code in the license memory.

10. The server apparatus of claim 2, wherein the acquiring module comprises a display module configured to display the change contents, the system individual identification information and the license code group identification information to be notified to the license issuing module, and
the acquiring module notifies the license issuing module of the change contents, the system individual identification information and the license code group identification information, when a user inputs a notification instruction.

11. The server apparatus of claim 2, wherein the controller adds authentication information to information indicating the function or the hardware circuit set to be unusable, and stores the added information in the license memory, when the usable function or hardware circuit is set to be unusable again by the license code, wherein the authentication information indicates that the information has been issued by the license issuing module.

12. A communication system comprising:
a server apparatus configured to register a plurality of phone terminals; and
a license issuing apparatus configured to be connected to the server apparatus via a communication network,
wherein the license issuing apparatus comprises:
a generator configured to generate a license code based on a change request of a function or a hardware circuit notified from the server apparatus, wherein the license code is code to permit the use of at least one function or hardware circuit among a plurality of functions or hardware circuits, or to expand a capacity, wherein the plurality of functions or hardware circuits is concerned with exchange processing among the phone terminals; and
a transmitter configured to transmit the license code to the server apparatus,
wherein the server apparatus comprises:
a license memory configured to selectively store the license code transmitted from the license issuing apparatus;
a license setting module configured to set the corresponding function or the corresponding hardware circuit to be usable/unusable based on the license code stored in the license memory;
an information memory configured to store information of at least a part of the license code;
an acquiring module configured to acquire the license code corresponding to the function or the hardware circuit to be changed by communication with the license issuing apparatus, when a change request of the function or the hardware circuit occurs;
a determining module configured to compare the license code acquired by the acquiring module with the information stored in the information memory, and determine whether or not the license code acquired by the acquiring module is valid based on the comparison result, and generate a valid license code when license code is determined to be valid; and
a control module which stores the valid license code in the license memory.

13. The communication system of claim 12, wherein the server apparatus further comprises a notifying module configured to notify the license issuing apparatus of change contents concerning the function or the hardware circuit, after storing the license code in the license memory, and
the license issuing apparatus comprises a processor configured to perform the processing of calculating a refund of a purchase price of a license in accordance with the number of the functions subjected to use limitation or the number of the hardware circuits set to be unusable, based on the change contents notified from the server apparatus, to pay the refund to a user of the server apparatus.

14. The communication system of claim 12, wherein the server apparatus further comprises a notifying module configured to notify the license issuing apparatus of change contents concerning the function or the hardware circuit, after storing the license code in the license memory, and
the license issuing apparatus comprises a processor configured to transmit, to the server apparatus of a notify source, the license code corresponding to all or a part of the number of the functions subjected to use limitation or the number of the hardware circuits set to be unusable, based on the change contents notified from the server apparatus, and transmit, to a server apparatus other than the server apparatus of the notify source, a license code to change, to a usable state, all or a part of the functions or the hardware circuits set to be unusable in the server apparatus of the notify source.

15. A method of controlling used in a server apparatus registering a plurality of phone terminals, comprising:
selectively storing a license code provided by a license issuing module in a license memory, wherein the license code is code to permit the use of at least one function or hardware circuit among a plurality of functions or hardware circuits or to expand a capacity, wherein the plurality of functions or hardware circuits is concerned with exchange processing among the phone terminals;
setting the corresponding function or the corresponding hardware circuit to be usable/unusable based on the license code stored in the license memory;
storing information of at least a part of the license code in a information memory;
acquiring the license code corresponding to the function or the hardware circuit to be changed by communication with the license issuing module, when a change request of the function or the hardware circuit occurs;
comparing the license code with the information stored in the information memory;
determining whether or not the license code acquired by the acquiring module is valid based on a comparison result, and generating a valid license code when license code is determined to be valid; and
storing the valid license code in the license memory.

16. The method of claim 15, wherein the storing information includes storing system individual identification information beforehand given at a shipping time of the server apparatus, and license code group identification information indicating that one or a plurality of license codes belong to the same group,
the acquiring includes notifying the license issuing module of change contents as well as the system individual identification information and the license code group identification information stored in the information memory, to generate the license code, when the change request occurs,
the determining includes determining whether or not the system individual identification information and the license code group identification information at a time of notification thereof to the license issuing module match the system individual identification information and the license code group identification information included in the license code acquired from the license issuing module, and
the storing the valid license includes storing the valid license code in the license memory, when the system individual identification information and the license code group identification information match.

17. The method of claim 16, further comprising:
generating the license code group identification information based on predetermined conditions to store the license code group identification information in the information memory.

18. The method of claim 17, wherein the generating includes using at least one of an instruction from the outside, a reset time and a random for judgment of the conditions.

19. The method of claim 16, wherein the determining includes comparing the system individual identification information and the license code group identification information obtained by a check sum with the system individual identification information and the license code group identification information at the time of the notification thereof to the license issuing module, when the check sum is added to the license code, wherein the check sum authenticates that the license code is issued by using the system individual identification information and the license code group identification information.

20. The method of claim 16, wherein the determining includes comparing the order identification information with order identification information of the license code stored in the license memory, and determining whether or not the license code acquired from the license issuing module is new based on a comparison result, when order identification information indicating an application order of the license code is added to the license code, and
the storing the valid license code includes storing the license code in the license memory, when the determining module determines that the license code acquired from the license issuing module is new.

21. The method of claim 20, wherein the determining includes determining whether or not the system individual identification information and the license code group identification information at the time of the notification thereof to the license issuing module match the system individual identification information and the license code group identification information included in the license code acquired from the license issuing module, and
the determining includes comparing order identification information of the license code which is determined to match, with the order identification information of the license code stored in the license memory, and determining whether or not the license code acquired from the license issuing module is new, based on the comparison result.

22. The method of claim 16, wherein the storing the valid license code includes storing the license code in the license storage module or ignores the license code, erases the license code group identification information stored in the information memory, and then generating new license code group identification information.

23. The method of claim 16, further comprising:
a notifying the license issuing module of change contents concerning the function or the hardware circuit, after storing the license code in the license memory.

24. The method of claim 16, wherein the acquiring includes displaying the change contents, the system individual identification information and the license code group identification information to be notified to the license issuing module, and
the acquiring includes notifying the license issuing module of the change contents, the system individual identification information and the license code group identification information, when a user inputs a notification instruction.

25. The method of claim 16, wherein the storing the valid license code includes adding authentication information to information indicating the function or the hardware circuit set to be unusable, and storing the added information in the license memory, when the usable function or hardware circuit is set to be unusable again by the license code, wherein the authentication information indicates that the information has been issued by the license issuing module.
